(19) United States
(12) Patent Application Publication
(10) Pub. No.: US 2019/0287467 A1
(43) Pub. Date: Sep. 19, 2019

(54) METHOD FOR CONTROLLING A DISPLAY ARRANGEMENT

(71) Applicant: VISTEON GLOBAL TECHNOLOGIES, INC., Van Buren Township, MI (US)

(72) Inventors: Alexandra Ledermann, Sinzheim (DE); David M. Whitton, Saline, MI (US)

(73) Assignee: VISTEON GLOBAL TECHNOLOGIES, INC., Van Buren Township, MI (US)

(21) Appl. No.: 16/358,229

(22) Filed: Mar. 19, 2019

(30) Foreign Application Priority Data
Mar. 19, 2018 (EP) 18162540.1

(51) Int. Cl. G09G 3/34

(52) U.S. Cl. CPC G09G 3/3426; G09G 2320/0626; G09G 2320/041

(57) ABSTRACT

A method for controlling a display arrangement controls the quality of representation of information on the display and heating of the display. In the event of a maximum permitted temperature being reached or exceeded in an area of the display, a light source is reduced in brightness or is switched off in the affected area. An adaptation of a content item to be represented on the display of the display arrangement is made to those areas in which no reduction in the brightness and/or no switching-off of the associated light source take place.

### CROSS REFERENCE TO RELATED APPLICATIONS

This application claims the benefit of European Patent Application No. 18162540.1 filed on Mar. 19, 2018, entitled “METHOD FOR CONTROLLING A DISPLAY ARRANGEMENT,” which is incorporated by reference in its entirety in this disclosure.

### TECHNICAL FIELD

This disclosure relates to a method for controlling a display arrangement in which a display with a backlight with several light sources is provided, whereby by means of one temperature sensor in one area or by means of several temperature sensors distributed over a surface of the display in several areas of the surface of the display, a temperature measurement is performed in each case and the measured temperature compared in each case with a specified, maximum permitted temperature.

### BACKGROUND

In many areas of technology, display arrangements in a variety of designs are used to represent or display information. Examples that can be named are equipment and systems such as hi-fi equipment, computers, household equipment or machines and systems in production centres. The use of such display arrangements is also common in vehicles in order to show the driver information about a driving status of the vehicle such as speed, engine revolutions, engine temperature, tank fill level or additional information concerning modules in the vehicle, for example a sound system, an air conditioning unit or a navigation system and others.

Equipping display arrangements or displays with a backlight illuminating a display of the display arrangement so as to make it easier to recognise the information shown on the display under different light conditions is known from the prior art.

For this purpose, arranging lighting elements for example behind or next to an image-generating surface of an LCD display, short for Liquid Crystal Display, of a TFT display, short for Thin-Film Transistor Display, or of an OLED display, short for Organic Light Emitting Diode display, is known.

The light emitted from dot-shaped or rod-shaped lighting elements or light sources must be distributed as evenly as possible over the whole surface of the display of the display arrangement. With active surfaces with small display dimensions, the light is usually fed in on one face of a light guide or a diffuser. In practice, such a light guide may be designed as a flat sheet made from a transparent plastic such as PMMA. The light guide, which for example is arranged behind an LCD display, has what are known as extractors which remove the light from the light guide. In this way the light emitted from the light source is distributed evenly over the surface of the LCD display and shines through the LCD display from the rear in a direction in which an observer is located.

In order to increase the luminance, the lighting elements may also be applied to two—for example opposing—faces, or all four faces of such a light guide or of a diffuser.

An alternative to the named design consists of arranging lighting elements in the form of a matrix, i.e. in several rows with several columns, behind the image-generating surface of a display arrangement.

It is known from the prior art to project information into the field of vision of a user, for example a vehicle operator such as a car driver or a pilot, by means of a head-up display. The term head-up display, also shortened to HUD, is used to mean a display system in which the user can essentially keep his or her head position or line of vision in its original orientation to view the displayed information. Such head-up displays generally have an image-generating unit, which provides the information to be represented in the form of an image, an optics module which allows the passage of the beam within the head-up display as far as an exit opening and is also referred to a mirror optics, and also a light-permeable reflection surface for the generation of an image or content to be displayed. In some designs of such head-up displays, the image-generating unit is designed as an LCD display, a TFT display or a mixture of the two technologies (TFT-LCD) and has the disadvantages described below—partly caused by a backlight—of the prior art.

In a head-up display, the optics module guides the image generated by the image-generating unit, in particular a display arrangement, onto the light-permeable reflexion surface, which is also termed a combiner. The vehicle operator sees the reflected information from the image-generating unit and simultaneously the actual environment behind the windscreen. As a result, the attention of a vehicle operator, for example when he or she is driving a motor vehicle, remains focussed on what is happening in front of the vehicle, whilst he or she can register information projected into the field of vision.

Information that can be represented by a display arrangement and also by a head-up display includes the indication of operating statuses such as information regarding speed, engine revolutions, payload, instrumentation and also information from a navigation system, radar system or target detection system. Over and above this it is possible, for example in motor vehicles, to also display information on restrictions currently applicable to the route, such as prohibitions on overtaking or speed limits, or the current setting of the adaptive cruise control, abbreviated to ACC.

Depending on the actual ambient temperature and the self-heating of the display arrangement, which is essentially caused by the operation of the backlight, measures must be taken to avoid thermally induced damage to the image-generating unit of the display arrangement. For example, damage to a layer of an LCD display containing liquid crystal or to the polarisers should be prevented.

Such heating-up of the display arrangement can involve the whole area of a display. Mostly, however, such heating-up is confined to a part of the whole area of the display used.

In accordance with the prior art, one possibility for protecting a display or a display arrangement consists of uniformly reducing the brightness of the backlight when a specified temperature is reached or exceeded on the surface of the display. The uniform reduction of the brightness of the backlight over the whole area of the display is also termed entire-surface or global dimming.

Such global dimming can be achieved easily but, by influencing the representation of the whole image, it results in a worsening of the quality of representation on the display of the display arrangement. In addition, power savings achievable through global dimming are very limited.

From US 2009 021955 A1 a transit vehicle lighting system is known which has several LED-based lighting elements for the provision of interior lighting. A control network comprises a plurality of slave nodes for controlling the LED-based lighting elements and a master node for controlling the slave nodes. The master node can be connected to the slave nodes by means of a combined power bus and daisy chain and hence permits separate control of the individual slave nodes. Each slave node can contain a power regulator and a controller for sending a ‘desired current’ command to the power regulator and can adjust the desired current based on temperature measurements or a recorded age of the controlled LEDs. In addition, provision is made for an optical sensor to be able to provide automatic dimming and for a reduced number of LEDs, short for light-emitting diode, to be able to be used in an emergency mode.

US 2012 013601 A1 describes a stereoscopic image display device which has a frame rate conversion unit that splits 3D input data into image data relating to a left eye and image data relating to a right eye.

The task to be solved by means of this stereoscopic image display device and the associated method consists of providing a backlight by means of which 3D crosstalk is reduced. Here a backlight control mechanism is disclosed which controls the brightness of the backlight unit, which is subdivided into several local dimming zones, separately for each individual dimming zone. For this purpose a light source control unit is provided which generates light source control signals for each of the local dimming zones of the backlight unit as a response to what are known as backlight control data.

JP 2013 222 515 A relates to a liquid crystal display device and in particular a backlight of the liquid crystal display device which for example has light sources designed as LEDs. The task to be solved consists of preventing thermal destruction of the ICs and LEDs in the arrangement.

To solve this task, a backlight is provided which is subdivided into a plurality of areas, whereby each of these areas has several LED elements which are connected to a separate driver circuit. Additionally, provision is made to control the driver circuits by means of a central control system, dependent on an image to be displayed.

Both global dimming and a local dimming restricted to subareas of the display of the display arrangement are associated with an at least partial reduction in the brightness of the backlight and lead to a worsening of the contrast of what is displayed. Under certain conditions, for example when the sun shines very brightly onto the surface of the display arrangement, this can result in the user no longer being able to see the information on the display. Such a loss of information, however, is not acceptable when driving a motor vehicle for example.

Hence there is a need for an improved solution for protecting a display in a display arrangement.

### SUMMARY

A method for controlling a display arrangement with which thermal damage of a display of a display arrangement is reliably prevented is provided. In addition, the quality of the representation of information on the display should be improved in the event that impermissible heating of the displays is detected.

The task is solved by a method with the features according to Patent Claim 1 of the independent patent claims. Embodiments are cited in the dependent Patent Claims 2 to 10.

The solution provides for detection of a temperature on a surface of a display arranged in a display arrangement to be performed in order to identify a critical temperature state and to prevent thermally induced damage of the display.

The detection of the temperature on the surface of the display must be performed in several locations or areas. For this, provision may be made for example to arrange temperature sensors in the form of a matrix over the display surface, whereby each temperature sensor records a temperature in an assigned area or subarea of the display surface.

Through such a measurement of the temperatures in several areas on the surface of the display, it becomes possible to record temperature differences on the display surface and for example to detect an area on the display surface in which a specified maximum permitted temperature is reached or exceeded. Here it is also possible for several areas on the display surface to be detected in which the specified maximum permitted temperature has been reached or exceeded. Through the arrangement of the temperature sensors it simultaneously becomes possible to detect areas on the display surface in which the specified maximum permitted temperature is not reached.

In an area in which the achieving or exceeding of the specified maximum permitted temperature has been detected, a local—i.e. confined to this area—reduction in the brightness of the backlight or a switching-off of the light sources of the backlight responsible for this area can be achieved.

If reaching or exceeding of the specified maximum permitted temperature is detected in several areas, the reduction in the brightness of the backlight or a switching-off of the backlight responsible for the area is performed in several areas.

In addition, provision is made to match the number of areas in which a local reduction in the brightness of the backlight or a switching-off of the backlight is possible to the number of areas envisaged for temperature measurement. In this case, a temperature sensor is allocated to each area of the backlight which can be dimmed or switched off.

Detailed temperature measurements may be performed with a matrix arrangement of temperature sensors on a display of a display arrangement. Taking into account the mounting conditions of the display arrangement in the vehicle, different external temperatures and possible exposure to solar radiation, areas are determined on the display which must be dimmed or switched off under certain conditions such as a temperature or a surface temperature of the display. Thereby data or data sets, for example for each vehicle model or product line, can be generated and stored.

In this case it is sufficient to perform detection of the temperature on the surface of the display or in the vicinity of the surface at certain location. If, at this location, it is detected that a particular temperature has been reached, the associated stored data are retrieved and in the event that an influencing of the display of the display arrangement has been stored for this data, an associated action such as dimming or switching-off of certain areas on the display is carried out. A more complex arrangement of temperature sensors in matrix form on the surface of the display can hence be dispensed with.

Alongside the possibility of measuring temperatures using sensors arranged in a matrix form and the generation of data using measurement series when developing a display arrangement, it is also possible to use suitable simulation processes in order to generate such data and/or data sets which, controlled by a simple measurement of the temperature on the surface of the display or in the area surrounding the display, can be referred to.

A content item or an image to be represented on the display is altered in such a way that the content item or image can be shown in an area or in several areas of the display of the display arrangement in which the specified maximum permitted temperature has not been reached and not been detected. In such areas, the backlight can continue to be operated without a reduction in the brightness without the risk of damage of the display in this area. In such areas, the displaying of content items or images to be represented can continue to take place.

Such a content item or image to be represented extends in two dimensions, whereby a first dimension is usually referred to as an image height or a height and a second dimension referred to as an image width or a width.

In order to show a content item that is to be represented on the display of the display arrangement in the areas of the display in which the specified maximum permitted temperature has not been reached, the content item to be represented is adapted. Adaptation is performed for example in such a way that the content to be represented can be shown in one or more areas available for showing content.

Such an adaptation of the content items or image with information to be represented should be understood to mean, for example, a reduction in the size or a change to the resolution.

A reduction in the size may occur in one dimension or preferably in two dimensions; a reduction in the size can take place while still maintaining a ratio, such as the aspect ratio.

A further alternative possibility for adapting a content item or an image to be represented consists of cutting out an area of the content item or image originally to be represented and to only show the cut-out area on the display, whereby it is shown in one or more areas in which the specified maximum permitted temperature has not been detected.

Similarly, several areas can be cut out of the content item or image originally to be represented and shown in the areas still available for displaying content. It is thereby possible, for example, to cut out two areas and show them in two separate areas of the display still remaining available for showing content.

Since, in a customary representation on a customary display, a content item to be represented only contains information, such as engine revolutions, tank contents or the vehicle's range or an engine temperature in certain areas of the display and the areas between the represented information do not have any important information for the driver and, for example, represent only a kind of background image or structure to the display, information that is important for the driver can be cut out or extracted from the representation. The extracted information which can be shown in a small subarea of the display is represented in an area on the display of the display arrangement in which no achieving or exceeding of the maximum permitted temperature has been detected.

An alternative possibility consists of dividing the content item or image originally to be represented into two or more subareas. The subareas generated in this manner are shown in two or more areas on the display in which the specified maximum permitted temperature has not been detected. When dividing, additionally a reduction in the size or resolution of one or more generated subareas can be performed before the subareas are displayed. Alternatively it is also possible for the information extracted or cut out from the content to be represented, to be, as described above, shown divided into two or more subareas.

The content items or images represented in the areas of a noncritical temperature can be displayed with an unchanged brightness of the backlight or with a reduced brightness of the backlight.

The method can be used both with several light sources arranged on one face of a light guide or a diffuser and feeding in the generated light and with several light sources arranged on at least two faces.

The method can also be used with a backlight in which light sources are arranged in the form of a matrix.

The brightness of the backlight may be reduced, which may go as far as a switching-off of the backlight in certain areas of the display in which the specified maximum permitted temperature has been detected. At the same time, a need-based alteration, i.e. an adaptation of the content item to be represented on the display in accordance with the variants described above is carried out in order to show key information on the display in one or more areas on the display in which the specified maximum permitted temperature has not been detected.

Here it is also provided that those areas used to represent the adapted content item in which no reduction in the brightness or no switching-off of the associated light source takes place are a group of areas adjacent to each other on the display. Such a group preferably forms a rectangular or square area on the display, which can also be termed a matrix, in which the adapted content item is shown.

In addition, provision is made to arrange several light sensors distributed over the surface of a display of a display arrangement for example in the form of a matrix. The light sensors capture the light shining in from outside—which can also result in additional local heating of the display—onto the display surface. In accordance with the method, this additional information can also be used to prevent damage of the display and to improve the quality of representation of content items or information on the display.

In a scenario in which in subareas of the display the maximum permitted temperature has been detected as having been exceeded and two areas remaining available on the display for display purposes, in which the maximum permitted temperature has not been achieved, are still there for display purposes, it is possible to make a choice between the two areas depending on the light shining in measured by means of the light sensors. Representation of the adapted content item takes place in the area which experiences less light shining in from outside and, for example, is in shadow, which results in better perception of the represented information by the driver.

In addition, provision is made to use the method to control a display arrangement for the control of an LCD display. The method can also be used to control a head-up display arranged in a vehicle.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

Further details, features and advantages of embodiments of the invention are apparent from the following description of embodiments with reference to the associated drawings. The figures show the following:

FIG. 1: a schematic diagram of a display arrangement with a backlight arranged on two opposing faces from the prior art,

FIG. 2: a display arrangement with a backlight arranged on one face from the prior art,

FIG. 3: a display arrangement with an adapted representation on the display generated in one reduced area in accordance with the method,

FIG. 4: a display arrangement with an adapted representation on the display generated in two reduced areas in accordance with the method,

FIG. 5: a display arrangement with an adapted representation on the display generated in one reduced area in accordance with the method,

FIG. 6: an alternative form of an adapted representation on the display generated in one reduced area in accordance with the method,

FIG. 7: a display arrangement with a backlight arranged in the form of a matrix from the prior art,

FIG. 8: a display arrangement with an adapted representation generated in one reduced area in accordance with the method in a display arrangement according to FIG. 7 and

FIG. 9: a display arrangement with an adapted representation generated in two reduced areas in accordance with the method in a display arrangement according to FIG. 7.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

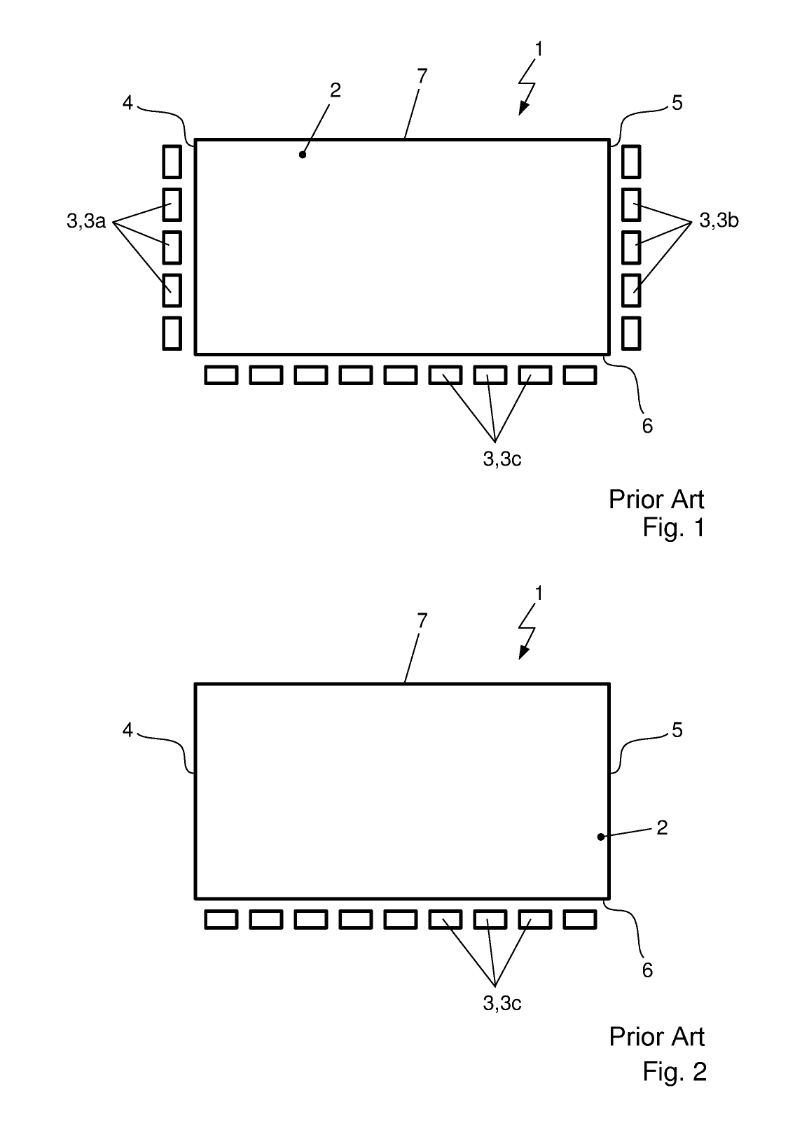

FIG. 1 shows a schematic diagram of a display arrangement 1 with a backlight arranged on two opposing faces 4, 5 of the display 2 from the prior art. The backlight has several light sources 3 and a diffuser (not shown) which functions as a light guide in the display arrangement 1 and may be designed in the form of a flat sheet made from a transparent plastic. The diffuser, that is to say the light guide, is arranged behind the display 2 and parallel to the display 2.

The light guide distributes the light introduced on the faces of rod-shaped or dot-shaped light sources 3 evenly across the surface of the display 2, in the manner known from the prior art.

In the example of FIG. 1, five first light sources 3a, which are designed for example as LEDs, are arranged on a first face 4 of the light guide and hence also of the display 2. In addition, five further light sources 3b are arranged on a second face 5 of the light guide and hence also of the display 2, whereby the first face 4 is opposite to the second face 5. In an alternative embodiment the further light sources 3 can also be arranged on a face 6, which is not opposite to the first face 4 but rather, for example, links the first face 4 to the second face 5.

One embodiment—by way of an example—with an arrangement of nine light sources 3c on a third face 6 that is not opposite to the first face 4 is shown by way of an example by means of the light sources 3c represented by dashed lines.

In general, it is possible by means of a light source 3 for a certain associated area in the light guide and hence in the display 2 to be illuminated. Hence by controlling the brightness of a light source 3 it is also possible to control the brightness of the associated area in the display 2, which takes place irrespective of the arrangement of the light sources 3, which can be arranged on both one or on several faces 4, 5, 6, 7 or in the form of a matrix behind the display 2.

On the display 2 of the display arrangement 1, content items or images are represented in the conventional manner; these may be information for a vehicle operator such as information regarding speed, engine revolutions, payload, instrumentation, and also information from a navigation system, and lots more. The content items or images are not shown in the Figures as these can be of any desired kind in the present method and are not restricted by the use of the method.

FIG. 2 shows a display arrangement 1 with a backlight arranged on a third face 6 from the prior art. The example shows nine light sources 3c which are designed for example as LEDs and are also arranged on a third face 6 of the light guide and hence also of the display 2. Alternatively, the nine light sources 3c could also be arranged on the fourth face 7 that is opposite to the third face 6.

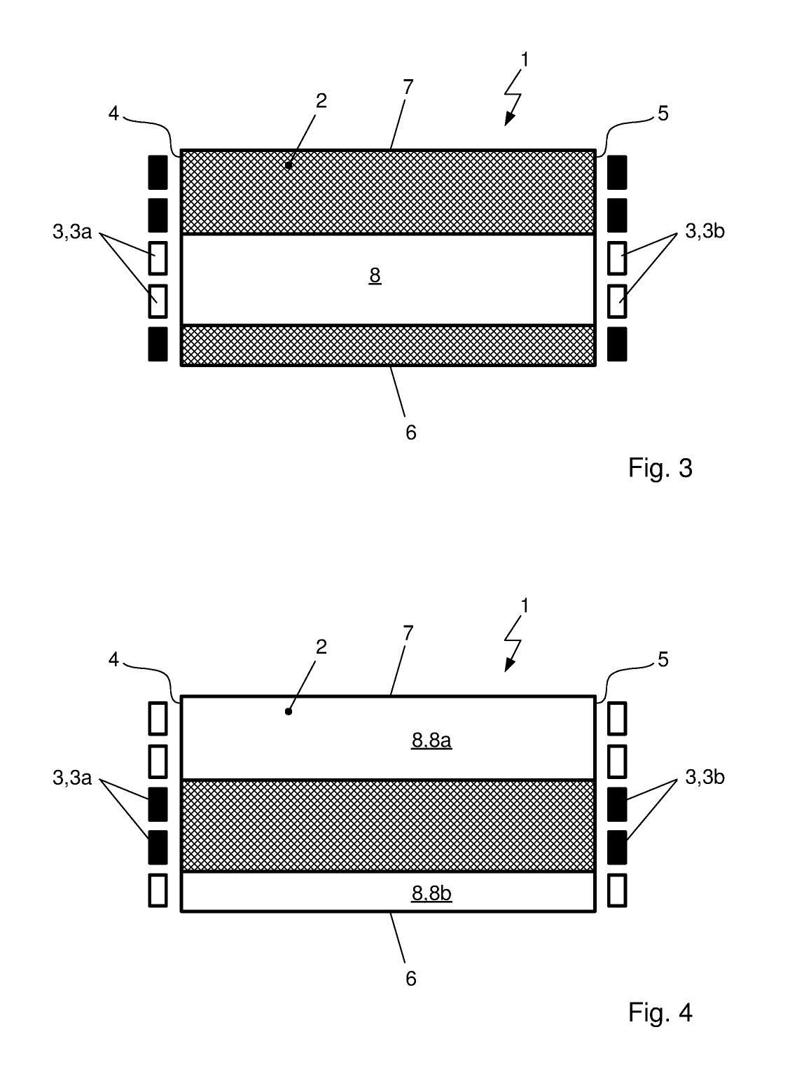

FIG. 3 shows a display arrangement 1 with an adapted representation generated in a reduced area 8 of the display 2 in accordance with the method. An area 8 reduced in this way can also be termed a reduced image area. FIG. 3 shows a display arrangement 1 already known from FIG. 1 with light sources 3 of a backlight which are arranged on two opposing faces 4, 5 of a light guide.

In accordance with the present method, the surface of the display 2 of the display arrangement 1 is monitored by means of a temperature sensor or several temperature sensors which are not shown in the Figures. Furthermore, a threshold value is specified for a maximum permitted temperature on the surface of the display 2, on which the temperature sensor or the temperature sensors are also arranged. This maximum permitted temperature constitutes a threshold value for proper operation of the display 2. The exceeding of the maximum permitted temperature can result in at least a local damage of the display, which must be prevented.

If, on a temperature sensor, a temperature is detected which corresponds to the maximum permitted temperature or lies above the latter, the brightness of the backlight is reduced for this area or preferably switched off in order, in this way, to prevent further heat generation caused by the backlight and hence possible damage of the display 2.

In the embodiment with a temperature sensor and the data or data sets generated and stored in a development process or a simulation, depending on the temperature values measured by the temperature sensor the associated data is retrieved and where required a reduction in the brightness of the backlight or a switching-off of the light source of the backlight responsible for certain areas carried out.

In the embodiment according to FIG. 3, a reaching or exceeding of the maximum permitted temperature is determined on the lower edge of the display 2 in an area of the third face 6 and also in an area of the fourth face 7 opposite to the third face 6 by means of several temperature sensors arranged in the areas in the form of a matrix. Furthermore, by means of further temperature sensors, an area is determined in which the current temperature lies below the maximum permitted temperature and which is arranged in the centre and below the centre of the display 2.

Here the method controls the backlight of the display 2 in such a way that only the two light sources 3a—shown light—on the first face 4 of the display 2 are switched on for the illumination of the display 2. At the same time, only the two light sources 3b—shown light—on the second face 5 opposite the first face 4 of the display 2 are switched on for the illumination of the display 2. The light sources not switched on are shown dark in the Figures.

Through the control of the light sources 3a, 3b, a reduced area 8 is generated on the display 2 in which a content item or image to be represented is shown and can be perceived by an observer. Such content may concern information on speed, engine revolutions, payload, instrumentation, and also information from a navigation system, and lots more. With the selective control of the light sources 3a, 3b of the backlight, the method achieves an adaptation of a content item or an image to be represented to the reduced area 8 available for the representation of content items or images.

Such an adaptation may occur through a reduction in the size of the content item to be represented. In the embodiment according to FIG. 3, the height of the image could be reduced, whilst the width is retained. A proportional reduction of the content to be represented, where both a height and a width of the content item to be represented are reduced, is also possible.

The light sources 3a, 3b remaining for the backlight which are switched on can be operated at a consistent brightness. Alternatively, the brightness of the light sources 3a, 3b can either be reduced or increased vis-à-vis an average value in normal operations. Using a higher brightness, the recognisability of an adapted content item shown smaller, for example a speed, can be improved.

An adaptation of a content item or image to be represented to the reduced area 8 still available for display may also occur such that only certain areas of the content to be represented in a normal mode of operation are selected, cut out and shown in a reduced area 8. Here the term ‘normal mode of operation’ is used to mean a state in which a maximum permitted temperature is not reached or exceeded in any area of the display 2 and the display 2 shows content items or images in their full dimensions.

Here it is possible for example to cut out of a content item to be represented, which comprises a current speed, engine revolutions and an indication of the tank content, only an area in which the current speed of the vehicle is indicated. In a reduced area 8 remaining for the representation of content on a display 2, the speed is then shown. All other content items such as the engine revolutions and the indication of the tank content are not shown. Such a reduction of the content still to be represented in the reduced area 8 enables the driver to operate the vehicle safely.

FIG. 4 shows a display arrangement 1 with a representation on display 2 generated in two reduced areas 8a, 8b in accordance with the method. When determining the temperatures by means of several temperature sensors arranged distributed in the form of a matrix, it was established that in an area slightly above the centre of the display 2 the maximum permitted temperature had already been reached in one or more locations. For the protection of the display 2, the associated backlight is switched off in the area. For the illumination of the display 2, the light sources 3a, 3b—shown light—are connected. In the exemplary embodiment there are formed a first reduced area 8a on the face 7 in the upper area of the display arrangement 1 and a second reduced area 8b which is shown in an area beneath an area switched off in the backlight on the display 2. The second reduced area 8b is arranged on the third face 6 of the display arrangement 1.

Both in the first reduced area 8a and in the second reduced area 8b the backlight can continue to be operated and hence content items or images displayed.

With this variant of the method, too, an adaptation of a content item or an image to be represented is performed in accordance with one of the techniques described above. It is possible, however, to split a content item selected in this manner into two sub-content items and to display the first sub-content item in the first reduced area 8a and the second sub-content item in the second reduced area 8b.

Alternatively, a first and a second area can be cut out of a content item to be represented. In this case the first area cut out, for example with information on current vehicle speed, is displayed in the first reduced area 8a and the second area cut out, for example with a current figure for engine revolutions, is displayed in the second reduced area 8b.

In this variant too, the light sources 3a, 3b remaining for the backlight can be operated at a consistent, reduced or elevated brightness.

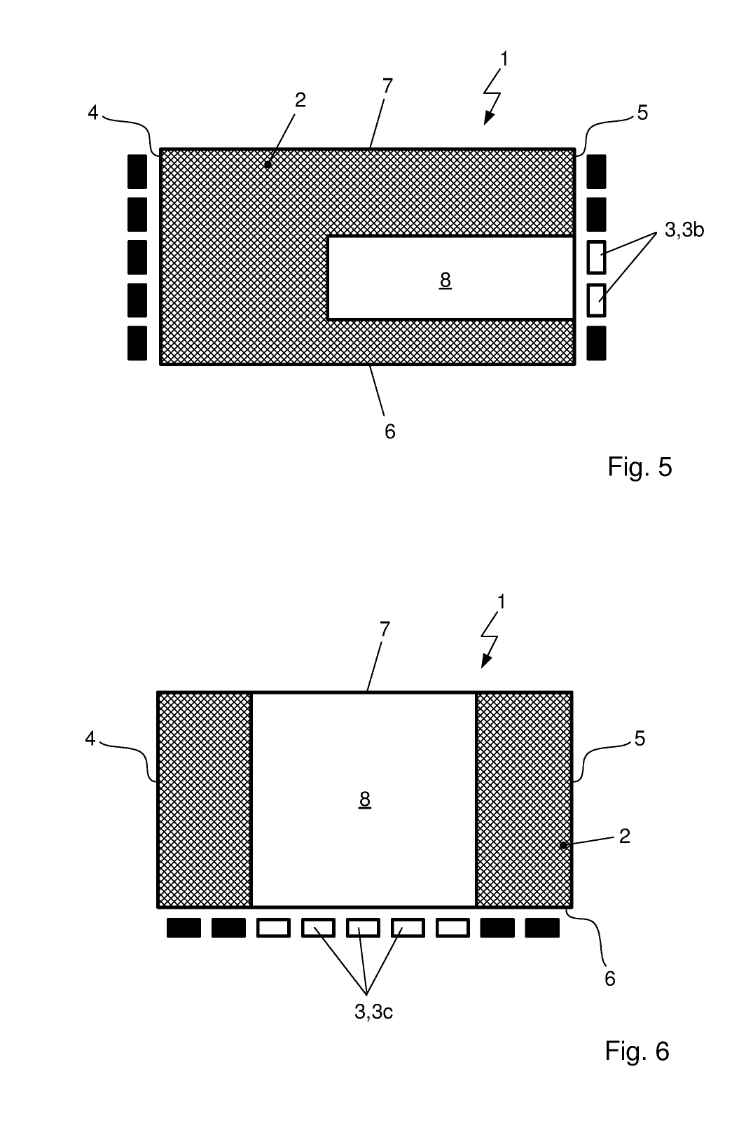

FIG. 5 shows a display arrangement 1 with an adapted representation on the display 2 generated in a reduced area 8 in accordance with the method. Unlike the representation from FIG. 3, in FIG. 5 the reduced area 8 is further restricted, since for example temperature sensors which are arranged in the area of the first face 4 have likewise registered a reaching of the maximum permitted temperature on the surface of the display 2.

For this scenario it is provided that, for the generation of a reduced area 8, only two light sources 3b on the second face 5 remain switched on. In the reduced area 8 it is possible for example to show a content item to be represented that is reduced in size. Similarly, a cut-out content item can also be displayed in the reduced area 8.

FIG. 6 shows an alternative form of an adapted representation on the display 2 generated in a reduced area 8 in accordance with the method. In this case, the backlight is formed from nine light sources 3, which for example may be designed as LEDs and are arranged on a third face 6 of the light guide. Temperature sensors arranged in areas of the first face 4 and the second face 5 have registered that a maximum permitted temperature has been reached or exceeded. The method reduces the area available on the display 2 for the representation of content items and images to the reduced area 8 through the fact that only five light sources 3c are operated on the third face 6 for the backlight of the display arrangement 1. Representation of reduced or cut-out content items takes place in the manner already described above.

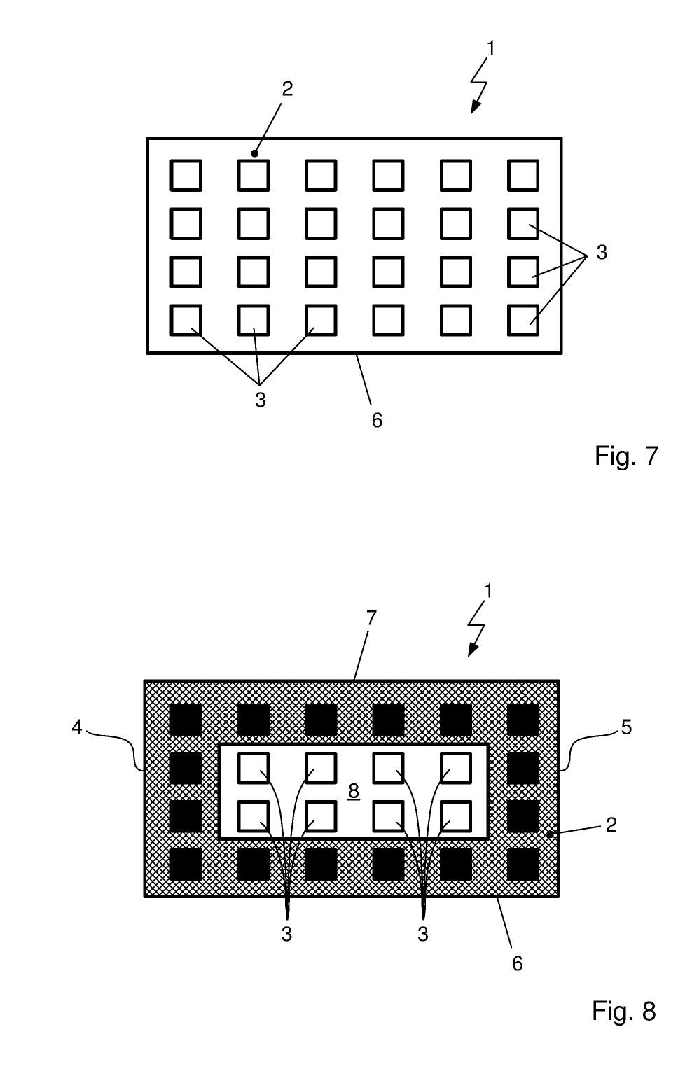

FIG. 7 shows a display arrangement 1 with a backlight arranged in the form of a matrix from the prior art, whereby six light sources 3 are arranged per row in a matrix containing four rows.

The method for controlling a display arrangement 1 can also be used with a backlight designed in such a way. As shown in FIG. 8 it is possible, for example in a scenario in which a reaching or exceeding of the maximum permitted temperature has been established in the areas of the faces 4, 5, 6, 7, for a switching-off of the light sources 3 lying in the outer areas of the display 2 to take place. In FIG. 8, for simplification, only the switched-on light sources 3 have been given the reference symbol although the switched-off light sources are also components of the matrix of the backlight.

A reduced area 8 in the centre of the display 2 is thereby formed in which the already-described representation of adapted content items or reduced content items is made possible. In this embodiment, too, the switched-on light sources 3 remaining for the backlight can be operated at a consistent, reduced or elevated brightness.

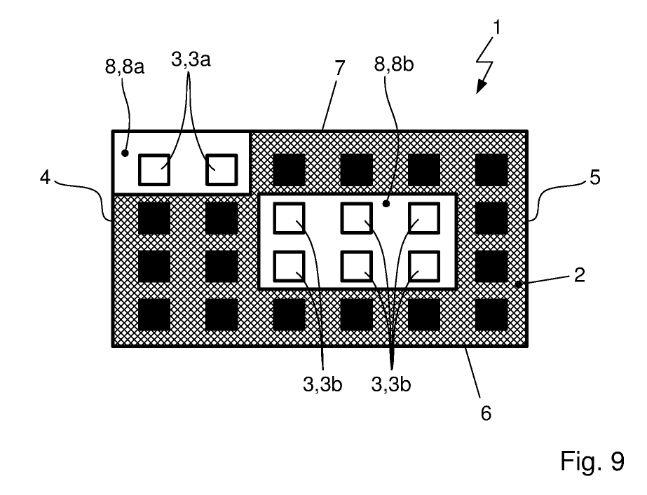

FIG. 9 shows a display arrangement 1 with an adapted representation on a display 2 generated in two reduced areas 8a, 8b in accordance with the method. In a display 2 with a backlight in matrix form in accordance with FIG. 7, it is established in several areas that the maximum permitted temperature has been exceeded on the surface of the display 2 by several temperature sensors arranged allocated to these areas.

In two remaining areas which in FIG. 9 are shown as a first reduced area 8a and a second reduced area 8b, the backlight continues to be operated. Here two light sources 3a illuminate the first reduced area 8a and six light sources 3b the second reduced area 8b. In both areas 8a, 8b it is possible, without the risk of a temperature-induced damage of the display 2, for representation of adapted content items to take place. In the example it would be possible, in a similar manner to FIG. 4, for a first cut-out area such as information about a current vehicle speed to be displayed in the first reduced area 8a and for a second cut-out area such as a current figure for engine revolutions to be displayed in the second reduced area 8b.

To improve the recognisability of the information represented in the reduced areas 8a, 8b, the backlight is operated for example at an elevated brightness, which has a brightness value that lies above an average brightness value in normal operations.

### LIST OF REFERENCE SYMBOLS

1 Display Arrangement
2 Display
3, 3a, 3b, 3c light source of the backlight
4 first face
5 second face
6 third face
7 fourth face
8, 8a, 8b reduced area, reduced image area

The detailed description and the drawings or figures are supportive and descriptive of the disclosure, but the scope of the disclosure is defined solely by the claims. While other embodiments for carrying out the claimed teachings have been described in detail, various alternative designs and embodiments exist for practicing the disclosure defined in the appended claims.

1. A method for controlling a display arrangement, in which a display with a backlight with several light sources is provided, whereby by means of a temperature sensor in one area or by means of several temperature sensors arranged distributed over a surface of the display in several areas of the surface of the display a temperature measurement is performed in each case and the measured temperature compared in each case with a specified, maximum permitted temperature, wherein when the maximum permitted temperature is reached or exceeded in one area of the display, a reduction in the brightness or a switching-off of the light source of the backlight associated with this area takes place and that an adaptation of a content item to be represented on the display of the display arrangement to those areas in which no reduction in the brightness and/or no switching-off of the associated light source take place is performed.

2. The method in accordance with claim 1, wherein an adaptation in a first dimension is performed in which a reduction of an image height of the content item to be represented takes place.

3. The method in accordance with claim 1, wherein an adaptation in a first and a second dimension is performed in which a reduction of an image height and a reduction of an image width of the content item to be represented takes place.

4. The method in accordance with claim 1, wherein the adaptation is a cut-out section of the content item to be represented is selected, or a content item to be represented is provided in a new form or newly compiled and generated.

5. The method in accordance with claim 1, wherein the adaptation is a reduction in the resolution of the content item to be represented, of the content item adapted in one or two dimensions, or of the cut-out section from the content item to be represented, takes place.

6. The method in accordance with claim 1, wherein those areas used for the representation of the adapted content in which no reduction in the brightness or no switching-off of the associated light source take place are a group of areas adjacent to each other on the display.

7. The method in accordance with claim 1, wherein the light sources of the backlight are provided in the form of several light sources arranged on one of the faces.

8. The method in accordance with claim 1, wherein the light sources of the backlight are provided distributed across a surface of the display in the form of a matrix.

9. The method in accordance with claim 1, wherein the display arrangement is provided with several light sensors arranged distributed over the surface of the display for the measurement of light shining in from outside onto the display.

10. The method in accordance with claim 1, wherein the reduction in the brightness or a switching-off of the light source associated with areas of the backlight occurs as a function of data stored in a data set, whereby the data from the data set are selected as a function of a measured temperature value.

11. A method for controlling a display arrangement, the method comprising:
providing a display including a backlight having one or more light sources and a display surface, wherein the display surface cooperates with and receives light projected from the one or more light sources;
providing one or more temperature sensors proximate the display surface to monitor temperature of the display surface;
measuring a temperature of at least one portion of the display surface with the one or more temperature sensors;
comparing the measured temperature of the at least one portion of the display surface against a stored value representing a maximum permitted temperature of the display surface;
adjusting the one or more light sources of the backlight when the measured temperature meets or exceeds the maximum permitted temperature of the at least one portion of the display surface;
generating an adapted content item to be represented on at least one portion of the display surface, wherein the adapted content item generated for representation on at least one portion of the display surface that does not exceed the maximum permitted temperature of the display surface.

12. The method of claim 11, wherein the step of generating an adapted content item further comprises generating an adapted content item in a first dimension by reducing an image height of the content item to be represented on the display surface.

13. The method of claim 11, wherein the step of generating an adapted content item further comprises generating an adapted content item in a first dimension by reducing an image height and in a second dimension by reducing an image width of the content item to be represented on the display surface.

14. The method of claim 11, wherein the step of generating an adapted content item further comprises generating an adapted content item by generating a cut-out section of the content item to be represented on the display surface.

15. The method of claim 11, wherein the step of generating an adapted content item further comprises generating an adapted content item by reducing resolution of the content item to be represented on the display surface.

16. The method of claim 11, wherein the step of adjusting the one or more lights sources of the backlight when the measured temperature meets or exceeds the maximum permitted temperature of the at least one portion of the display surface further comprises reducing the brightness of the one or more light sources of the backlight to reduce the temperature of the at least one portion of the display surface.

17. The method of claim 11, wherein the step of adjusting the one or more lights sources of the backlight when the measured temperature meets or exceeds the maximum permitted temperature of the at least one portion of the display surface further comprises switching off the one or more light sources of the backlight to reduce the temperature of the at least one portion of the display surface.

18. A display arrangement comprising:
a display including a backlight having one or more light sources and a display surface, wherein the display surface cooperates with and receives light projected from the one or more light sources;
one or more temperature sensors proximate the display surface, wherein the one or more temperature sensors measure temperature of at least one portion of the display surface; and
a system for controlling the display arrangement, wherein the system compares the measured temperature of the at least one portion of the display surface against a stored value representing a maximum permitted temperature of the display surface and adjusts the one or more light sources of the backlight when the measured temperature meets or exceeds the maximum permitted temperature of the at least one portion of the display surface,
wherein the system for controlling the display arrangement generates an adapted content item to be represented on at least one portion of the display surface, wherein the adapted content item generated for representation on at least one portion of the display surface that does not exceed the maximum permitted temperature of the display surface

19. The display arrangement of claim 18 wherein the one or more light sources of the backlight arc distributed across the display surface in the form of a matrix.

20. The display arrangement of claim 18 further comprising one or more light sensors arranged distributed over the display surface to measure light shining in from outside onto the display surface.
